(19) United States
(12) Patent Application Publication
(10) Pub. No.: US 2024/0429484 A1
(43) Pub. Date: Dec. 26, 2024

(54) HEAT DISSIPATION CELL DEVICE IN AIR-COOLED BATTERY

(71) Applicant: H GREEN POWER Inc., Chungju-si (KR)

(72) Inventors: Ba-Wi JEONG, Chungju-si (KR); Woo-Hyung KIM, Chungju-si (KR); Jae-Yeon RYU, Chungju-si (KR)

(21) Appl. No.: 18/733,858

(22) Filed: Jun. 5, 2024

(30) Foreign Application Priority Data
Jun. 23, 2023 (KR) 10-2023-0080744

(51) Int. Cl. H01M 10/6551; H01M 10/6562

(52) U.S. Cl. CPC H01M 10/6551; H01M 10/6562

(57) ABSTRACT

According to a heat dissipation cell device 10 for an air-cooled battery according to the present embodiment, a first heat dissipation part 20A, which is provided on a cell cooling portion 11 of a first cell 10A, and a second heat dissipation part 20B, which is provided on a cell cooling portion 11 of a second cell 10B attached to the first cell 10A through a cell surface contact portion 15, cool heat, which is generated when the first and second cells 10A and 10B are charged and discharged, by means of contact with air, such that air-cooling efficiency is improved by heat dissipation from the cells, and surface treatment for heat dissipation provides particle shapes and implements hydrophobicity to exhibit a water repellency effect.

### CROSS-REFERENCE TO RELATED APPLICATION

The present application claims priority to Korean Patent Application No. 10-2023-0080744, filed on Jun. 23, 2023, the entire contents of which are incorporated herein for all purposes by this reference.

### BACKGROUND OF THE INVENTION

### Field of the Invention

The present invention relates to a cell for an air-cooled battery, and more particularly, to an air-cooled battery with air-cooling efficiency improved by a heat dissipation cell device capable of dissipating heat by means of surface treatment.

### Description of the Related Art

In general, a battery module made by grouping a plurality of secondary batteries is applied as a battery. Because heat is generated from the secondary battery and heat is generated during charging and discharging processes, it is necessary to always optimize module temperature control.

This is because the performance of the secondary battery deteriorates when a temperature of the battery module is higher than an appropriate temperature. In particular, a risk of explosion or ignition may be caused when a temperature is increased because the plurality of secondary batteries is densely disposed, and an excessively low temperature of the module may degrade the performance of the battery module.

Therefore, the battery performance depends on whether heat, which is generated during a process of charging and discharging a cell that is a group of the secondary batteries of the battery module, may be effectively dissipated to the outside through a casing.

To this end, thermally conductive resin may be applied to the cell to obtain an effect of dissipating heat by means of thermal conduction.

However, the method of cooling the secondary battery by using the thermally conductive resin requires a structure in which a hollow portion needs to be formed between the secondary batteries, and the hollow portion needs to be filled with conductive resin to dissipate heat by means of thermal conduction.

For this reason, a cell structure is changed, and a cell volume is increased by the application of the conductive resin, which inevitably increase a size of the battery module.

### SUMMARY OF THE INVENTION

The present invention is proposed to solve these problems and aims to provide a heat dissipation cell device for an air-cooled battery, in which the heat dissipation cell is subjected to surface treatment using components, such as a flow path or a cell cup part, related to cooling of a battery to improve air-cooling efficiency by means of heat dissipation from the cell, and the surface treatment for heat dissipation provides particle shapes and implements hydrophobicity to exhibit a water repellency effect.

In order to achieve the above-mentioned object, the present invention provides a heat dissipation cell device for an air-cooled battery, the heat dissipation cell device including: a cell; and a heat dissipation part provided to be in surface contact with the cell, in which the heat dissipation part cools heat, which is generated from the cell, in an air-cooled manner.

Furthermore, in order to achieve the above-mentioned object, the present invention provides a heat dissipation cell device for an air-cooled battery, the heat dissipation cell device including: a first cell; a second cell attached to the first cell through a cell surface contact portion; a first heat dissipation part provided on a surface of the first cell; and a second heat dissipation part provided on a surface of the second cell, in which the first heat dissipation part and the second heat dissipation part each cool heat, which is generated when the first cell and the second cell are charged and discharged, in an air-cooled manner.

Preferably, a surface of each of the first and second cells may be a cell cooling portion formed in a region inside a cell rim portion.

Preferably, the first heat dissipation part and the second heat dissipation part may each include: a surface treatment coating surface; and particles exposed from the surface treatment coating surface, and the surface treatment coating surface may be formed on the cell cooling portion.

Preferably, the surface treatment coating surface may include a coating thickness, the particles may be in point contact or surface contact with one another in an angled shape such as a quadrangular or triangular shape, and cross-sections of the particles having quadrangular or triangular shapes and penetrating into the coating thickness may be formed.

### BRIEF DESCRIPTION OF THE DRAWINGS

FIG. 1 is a configuration view illustrating that a heat dissipation cell device is applied to a battery module that constitutes an air-cooled battery according to the present invention.

FIG. 2 is a detailed configuration view of the heat dissipation cell device according to the present invention.

### DETAILED DESCRIPTION OF THE INVENTION

Hereinafter, embodiments of the present invention will be described in detail with reference to the accompanying exemplified drawings. Since the embodiments are only examples and may be implemented in various different forms by those skilled in the art to which the present invention pertains, the present invention is not limited to the embodiments described herein.

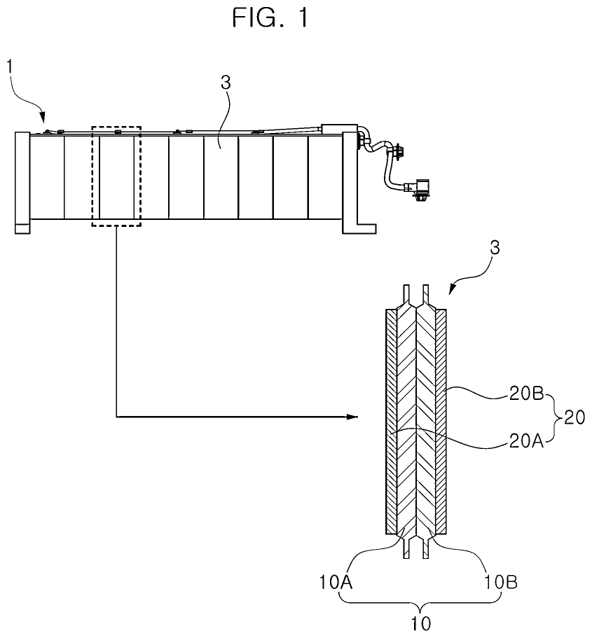

Referring to FIG. 1, the air-cooled battery includes a battery module 1 in which a plurality of heat dissipation cell devices 3 each having heat dissipation parts 20 applied to cells 10 is arranged in series.

For exemplary embodiment of the present disclosure, the cells 10 include a pair of first and second cells 10A and 10B being in surface contact with each other. The heat dissipation parts 20 include first and second heat dissipation parts 20A and 20B corresponding to the first and second cells 10A and 10B.

Therefore, the first heat dissipation part 20A is provided on an exposed surface of the first cell 10A, the second heat dissipation part 20B is provided on an exposed surface of the second cell 10B, and the first and second heat dissipation parts 20A and 20B respectively provide special surface treatment states to the exposed surfaces of the first and second cells 10A and 10B.

Therefore, when cooling air passes the first and second cells 10A and 10B, the heat dissipation cell device 3 may improve an air-cooling effect by means of the first heat dissipation part 20A specially surface-treated on the exposed surface of the first cell 10A and improve an air-cooling effect by means of the second heat dissipation part 20B specially surface-treated on the exposed surface of the second cell 10B.

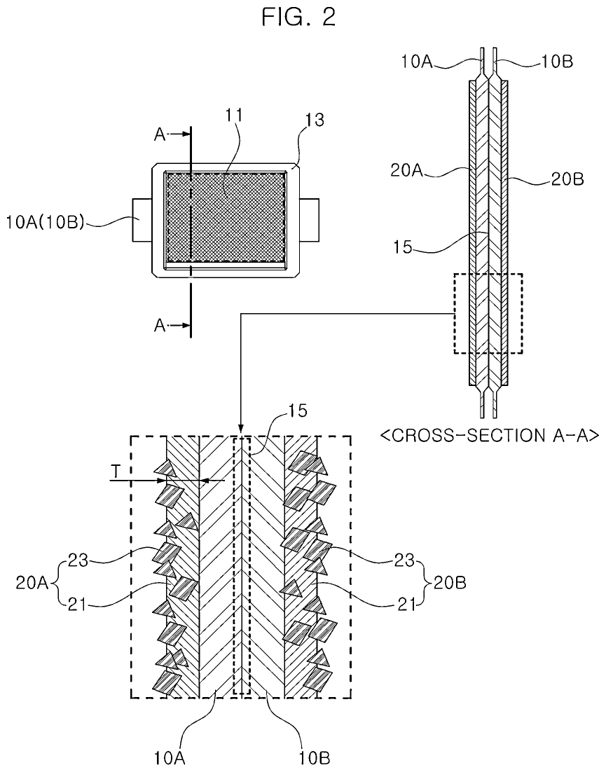

FIG. 2 exemplarily illustrates detailed configurations of the first and second cells 10A and 10B and the first and second heat dissipation parts 20A and 20B.

As illustrated, in the heat dissipation cell device 3, the first and second cells 10A and 10B attached to each other through a cell surface contact portion 15 are integrated, an inner space of a cell rim portion 13 is defined as a cell cooling portion 11, and the first and second cells 10A and 10B defines outer exposed surfaces in opposite directions. This is because the cell cooling portion 11 is connected to a flow path and a cell cup part that are part related to cooling of the battery to dissipate heat generated inevitably.

Therefore, in the cell cooling portion 11, the first and second heat dissipation parts 20A and 20B provide cell surface areas respectively formed on the first and second cells 10A and 10B. The cell surface areas account for about 80 to 90% of the overall surface area.

Referring to cross-section A-A, the first and second heat dissipation parts 20A and 20B of the heat dissipation parts 20, which are applied only to the cell cooling portions 11 of the first and second cells 10A and 10B without being applied to the cell rim portion 13 and the cell surface contact portion 15, each include a surface treatment coating surface 21 and particles 23.

For exemplary embodiment of the present disclosure, the surface treatment coating surface 21 is specially surface-treated on the cell surface of the cell cooling portion 11 and has a coating thickness T, and the coating thickness T is about 200 to 500 μm.

Further, the particles 23 penetrate the coating thickness T and protrude from the surface treatment coating surface 21, such that a rough surface such as sandpaper is applied to a surface of the surface treatment coating surface 21.

The particles 23 have a particle grit, which is a numerical representation of the coarseness of the surface treatment coating surface 21, the same as sandpaper grit, which is a numerical representation of the coarseness of sandpaper.

The particle 23 is an angularly shaped particle, such as a square or triangular shape, which is hydrophobic and creates a water repellent effect. As the surface area of the particles increases, the contact between the particles increases, resulting in greater heat conduction, and ultimately more contact with the cooling air.

The particles 23 penetrate into the coating thickness T and are distributed from the surface of the cell 10 to the surface of the coating surface. In particular, the particles 23 are in point contact with or surface contact with the first and second cells 10A and 10B.

Therefore, each of the first and second heat dissipation parts 20A and 20B provides hydrophobicity by means of the shapes of the particles 23, thereby providing the water repellency effect that prevents moisture from accumulating on the surface treatment coating surface 21 even when the cooling air is condensed.

Furthermore, the heat dissipation part 20 may not only be formed directly on the cell 10 but also be formed on a cell cover (not illustrated) configured to cover the cell 10. Furthermore, the surface treatment coating surface may be formed and the particles may be applied by performing several sequential processes or applying a coating solution containing particles.

The formation of the heat dissipation parts takes place prior to the assembly of the battery module, and may take place in the state of the first and second cells 10A (10B), which are the unit cells comprising the cell 10. In case that the cell cover is provided, the heat dissipation parts are formed on the cell cover assembled in advance.

As described above, the heat dissipation cell device 10 of the air-cooled battery according to the present embodiment includes a first heat dissipation part 20A provided in the cell cooling part 11 of the first cell 10A, and a second heat dissipation part 20B provided in the cell cooling part 11 of the second cell 10B, which faces the first cell 10A by the cell contact part 15.

By air-cooling the heat generated by the charging/discharging of the first and second cells 10A, 10B in contact with air, the air-cooled cooling efficiency is improved through the heat dissipation of the cells themselves, and in particular, the surface treatment for heat dissipation is hydrophobic due to the particle shape, and the water repellent effect is generated at the same time.

According to the air-cooled battery of the present invention, the surface-treated heat dissipation cell device is applied to the parts, such as the flow path and the cell cup part, related to cooling of the battery, such that the cell may dissipate heat to improve the air-cooling efficiency.

In particular, the particle shapes are added to the surface treatment of the cells, such that the hydrophobicity is provided by the water repellency function of the particles in addition to the heat dissipation function, which may prevent moisture from accumulating on the cell surface.

What is claimed is:

1. A heat dissipation cell device for an air-cooled battery, the heat dissipation cell device comprising:
a cell; and
a heat dissipation part provided to be in surface contact with the cell,
wherein the heat dissipation part dissipates heat, which is generated from the cell, in an air-cooled manner.

2. The heat dissipation cell device of claim 1, wherein a surface of the cell is a cell cooling portion formed to include a predetermined area in a space inside a cell rim portion.

3. The heat dissipation cell device of claim 2, wherein the heat dissipation part comprises:
a surface treatment coating surface formed on the cell cooling portion; and
particles exposed from the surface treatment coating surface.

4. The heat dissipation cell device of claim 3, wherein the surface treatment coating surface has a coating thickness, and
wherein the particles penetrate into the coating thickness and are distributed from a surface of the cell to a surface of the surface treatment coating surface.

5. The heat dissipation cell device of claim 4, wherein the particles are distributed from the surface of the cell to the surface treatment coating surface so as to be in contact with one another.

6. The heat dissipation cell device of claim 5, wherein the particles are in point contact or surface contact with one another.

7. The heat dissipation cell device of claim 6, wherein a cross-section of the particle has a quadrangular or triangular shape.

8. A heat dissipation cell device for an air-cooled battery, the heat dissipation cell device comprising:
a first cell;
a second cell attached to the first cell through a cell surface contact portion;
a first heat dissipation part provided on a surface of the first cell; and
a second heat dissipation part provided on a surface of the second cell,
wherein the first heat dissipation part and the second heat dissipation part each cool heat, which is generated when the first cell and the second cell are charged and discharged, in an air-cooled manner.

9. The heat dissipation cell device of claim 8, wherein a surface of each of the first and second cells is a cell cooling portion formed in a region inside a cell rim portion.

10. The heat dissipation cell device of claim 9, wherein the first heat dissipation part and the second heat dissipation part each comprise:
a surface treatment coating surface; and
particles exposed from the surface treatment coating surface, and
wherein the surface treatment coating surface is formed on the cell cooling portion.

11. The heat dissipation cell device of claim 10, wherein the surface treatment coating surface has a coating thickness, and
wherein the particles penetrate into the coating thickness and are distributed from a surface of the cell to the surface treatment coating surface so as to be in contact with one another.

12. The heat dissipation cell device of claim 11, wherein the particles are distributed from the surface of the cell to the surface treatment coating surface so as to be in contact with one another.

13. The heat dissipation cell device of claim 12, wherein the particles are in point contact or surface contact with one another.

14. The heat dissipation cell device of claim 13, wherein a cross-section of the particle has a quadrangular or triangular shape.

15. A heat dissipation cell device for an air-cooled battery, the heat dissipation cell device comprising:
a cell; and
a heat dissipation part provided to be in surface contact with the cell,
wherein the heat dissipation part comprises:
a surface treatment coating surface; and
particles applied onto the surface treatment coating surface, and
wherein surface treatment on the cell and distribution of particles are performed on first and second cells, which constitute the cell, before a battery module is assembled.
